(19) United States
(12) Patent Application Publication
(10) Pub. No.: US 2007/0295017 A1
(43) Pub. Date: Dec. 27, 2007

(54) In transit heating and cooling of passenger area of recreational vehicle

(75) Inventor: Bobby L. Pannell, Copper Canyon, TX (US)

Correspondence Address: James E. Bradley, P. O. Box 61389, Houston, TX, 77008-1389, US

(73) Assignee: Specific Climate Systems, Inc.

(21) Appl. No.: 11/472,744

(22) Filed: Jun. 22, 2006

(51) Int. Cl. F25B 27/00; B60H 1/32

(52) U.S. Cl. 62/236; 62/239

(57) ABSTRACT

A vehicle has a main and an auxiliary air conditioning system. The main system includes a main compressor driven by the main vehicle engine, a main condenser, a main evaporator, and a main fan for discharging air through the main evaporator into a driver area of the vehicle. A secondary evaporator is located in a cabinet in an additional area of the vehicle and is connected with the main compressor for receiving first refrigerant simultaneously with the main evaporator. An auxiliary air conditioning system is in the cabinet and includes an AC powered auxiliary compressor, an auxiliary condenser and an auxiliary evaporator. An on board auxiliary power provider is driven by an auxiliary engine to supply AC power to the auxiliary compressor. An additional area fan moves air through the auxiliary and secondary evaporators into the duct.

### FIELD OF THE INVENTION

This invention relates generally to air conditioning systems and in particular to a recreational vehicle having a common air handler for circulating vehicle air to be conditioned, temperature adjusted or otherwise modified through a plurality of heat exchangers each of which may be receiving either heating or cooling fluids from multiple sources.

### BACKGROUND OF THE INVENTION

As used herein, the term “recreational vehicle” or “vehicle” is used broadly to refer to self-propelled mobile homes, motor homes, trucks and commercial vehicles, as well as water-powered vehicles such as boats, houseboats and the like. The term “air conditioning” as used herein includes both heating and cooling of the air as well as dehumidifying and thus includes air refrigeration devices, heat pumps and other sources of hot fluids such as engine coolant which may be readily obtain from a vehicle movement inducing engine. The air conditioning may be provided by units mounted internally or externally of such vehicles.

In the case of air refrigeration, such a device typically comprises a compressor circulating a refrigerant serially through a condenser, a pressure reduction device such as an expansion valve or capillary tube and an evaporator coil where the serially connected devices operate as a closed system. The air conditioning unit for some recreational vehicles is mounted on the roof of the vehicle with a condenser coil exposed to the outside air and an evaporator coil exposed to the interior air in the vehicle. Such a unit is very similar to roof-mounted air conditioning units in commercial buildings and homes. Other recreational vehicles have one or more window-mounted air conditioner units or an internal floor-mounted evaporator console/air handler with an external compressor/condenser.

A recreational vehicle is often a multi-purpose vehicle that is especially popular with retired couples or families with small children. It makes an excellent camping device for weekends and short vacations. To overcome rising construction costs in manufacturing a vehicle and fuel costs associated with weight, it is very desirable to minimize any duplication of parts. Since the trend in van construction has been towards smaller van body sizes, the location and space for air conditioning units must be carefully planned and allocated in the construction of modem recreational vehicles.

Conventional recreational vehicles typically have an air conditioning system which is powered by an auxiliary A/C power source. Indeed, many recreational vehicles have multiple air conditioning systems, one of which may be powered by an on-board auxiliary A/C powered generator and another of larger capacity which is powered by conventional 120 volt utility company power. The combination of cooling from an engine-powered air conditioner and the on-board auxiliary powered generator is adequate in most instances to cool the recreational vehicle. Such a recreational vehicle, of course, has a large duplication of parts such as air handlers for the evaporator coils.

Other recreational vehicles use a single large air conditioning system which may be powered either from an on-board auxiliary powered generator, or a utility company power source but such recreational vehicles require a much larger on-board auxiliary engine driven generator unit. The space necessary for such a power generator unit and the cost of such generator unit is often a limiting factor. Further, the space required to house not only the auxiliary engine driven generator but additionally the large capacity air conditioning units may displace an unacceptable amount of living/storage space within the vehicle. It is known that the use of a large capacity air conditioning system in warm, as opposed to hot periods, cools the air without removing an adequate amount of moisture, thus requiring the temperature to be set to a relatively lower value for comfort.

Consequently, I designed a dual stage air conditioning system for a recreational vehicle as shown in my U.S. Pat. No. 5,205,130, which allows the use of a small on-board powered air conditioner to be used while traveling on the highway. The concept disclosed in the patent provides for an additional air conditioner system, both of which are placed in a single cabinet. When utility company power is available, such as at a rest stop, both air conditioning systems in the cabinet are operated from the utility company power whereby the vehicle engine powered air conditioning system is not required for any additional cooling of the vehicle.

There are times when air conditioning is required even though the outside temperature is only slightly too warn or too cool, when heated fluid from the vehicle engine could adequately heat the entire recreational vehicle or engine power supplied refrigerant could cool the entire vehicle, instead of just the front portion occupied by the driver. Separate air handlers have been employed on the few occasions that this has been tried for conditioning small recreational vehicles. Some have typically provided gas powered space heaters or portable heaters without vents to heat the interior of the recreational vehicle behind the driver's compartment. Some recreational vehicles have diesel-fired boilers to create hot water used in the potable water system. Also, it is known to circulate hot water from a diesel-fired boiler to a stand-alone heat exchanger with a fan for heating the vehicle.

### SUMMARY OF THE INVENTION

The vehicle of this invention has a main engine for propelling the vehicle and a main air conditioning system including a main compressor driven by the main engine for circulating a first refrigerant through a main condenser and a main evaporator. A main fan discharges air through the main evaporator into a driver area of the vehicle. An air supply duct extends along an additional area of the interior of the vehicle and has at least one outlet. An air handling cabinet is connected with the supply duct. A secondary evaporator is located in the cabinet and connected with the main compressor for selectively receiving first refrigerant simultaneously with the main evaporator.

The vehicle has an auxiliary air conditioning system including an AC powered auxiliary compressor that circulates a second refrigerant through an auxiliary condenser and an auxiliary evaporator that is located in the cabinet. The vehicle has an on board auxiliary power provider driven by an auxiliary engine for selectively supplying AC power to the auxiliary compressor. An additional area fan moves air through the secondary evaporator and the auxiliary evaporator into the duct.

The vehicle has a first in transit mode wherein the auxiliary air conditioning system is not operating and the main air conditioning system is operating along with the secondary evaporator. In this mode, the main air fan moves air cooled by the main evaporator into the driver area and the additional area fan moves air cooled by the secondary evaporator into the duct and the additional interior of the vehicle, The vehicle has a second in transit mode wherein both the main air conditioning system along with the secondary evaporator and the auxiliary air conditioning system are operating, along with the auxiliary power provider. In this mode, the main air fan moves air cooled by the main evaporator into the driver area, and the additional area fan moves air cooled by the secondary and auxiliary evaporators into the duct and the additional interior of the vehicle.

The vehicle may also have a diesel-fired boiler or hot water heater for creating hot water, such as used for a shower or a sink. The hot water created by may selectively circulated through a heat exchanger located in the air handling cabinet. The additional area fan could move air through this heat exchanger for heating air for discharge through the air ducts. Further, the same or another heat exchanger could be located in the air handling cabinet and connected in parallel to the vehicle's main cab heater, which receives hot coolant circulated by the main engine.

Other features and advantages of the present invention will be appreciated by those skilled in the art upon reading the detailed description which follows with reference to the attached drawings.

### BRIEF DESCRIPTION OF THE DRAWINGS

FIG. 1 is a perspective view of a recreational vehicle in which a common air handler cabinet, which cabinet also includes a dual stage AC powered air conditioning system, has been installed beneath the floor and which is connected to receive air temperature altering fluids from the recreational vehicle engine.

FIG. 2 is a sectional view of the air handler cabinet including a dual stage air conditioning system taken along lines 2-2 of FIG. 1.

FIG. 3 is a perspective view of the air handler and dual stage air conditioning unit cabinet shown in FIG. 1 with the top panel partially broken away and one side panel completely removed to show the four juxtaposed air temperature modifying heat exchangers.

FIG. 4 is a simplified electrical diagram of a control circuit which provides temperature control capability and supplies power to the air handler motor from the most energy efficient power source actively available.

FIG. 5 is a simplified flow diagram illustrating the paths of various fluids used to modify the temperature of air flowing through the air handler and juxtaposed coils.

### DETAILED DESCRIPTION OF THE PREFERRED EMBODIMENT

In the description which follows, like parts are indicated throughout the specification and drawings with the same reference numerals, respectively. The figures may not be drawn to scale and the proportions of certain parts may have been exaggerated for convenience of illustration.

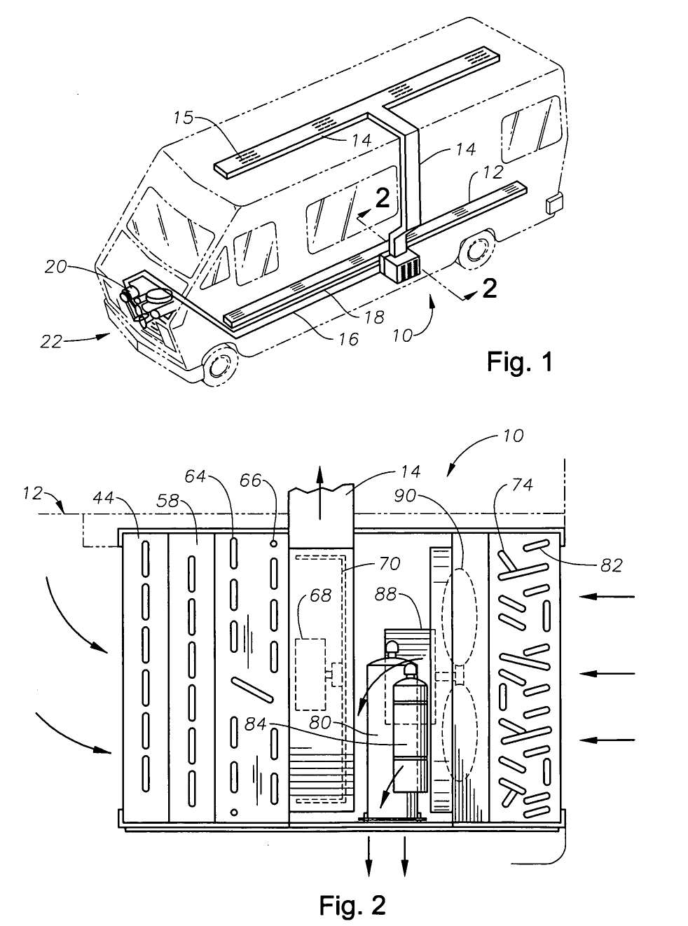

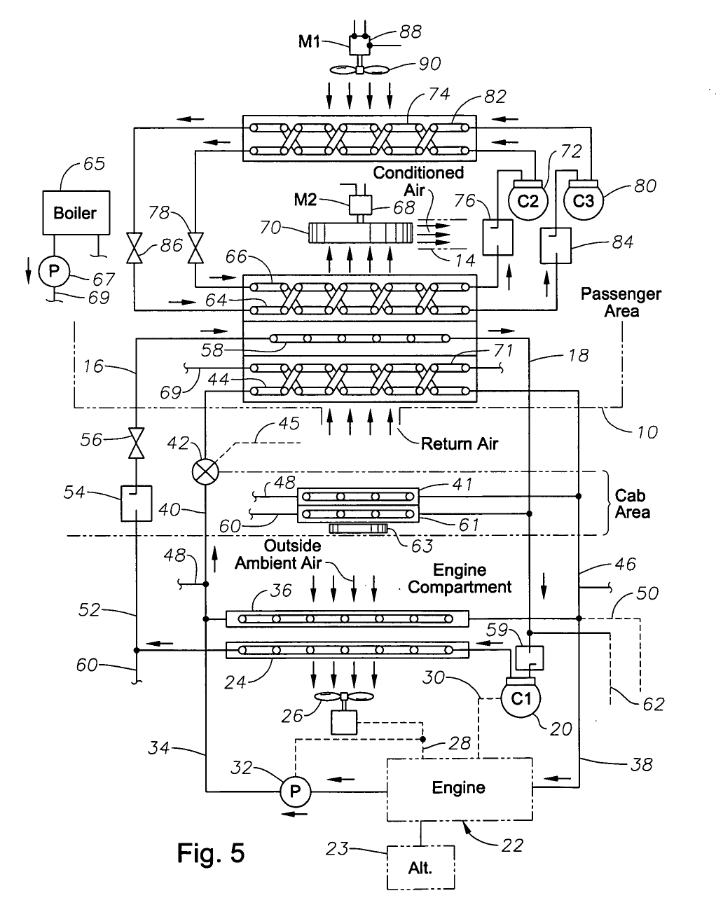

Referring now to FIG. 1, an air handler cabinet 10 is shown interconnected between a return air duct work 12 and a conditioned air output or supply duct work 14. Duct 14 extends along the interior of the vehicle and has a plurality of outlets 15. Air handler cabinet 10 may be located under the floor of the living space of the vehicle. In a preferred embodiment, the air handler cabinet 10 may include the two compressors of my previously referenced patent and the associated evaporator and condenser coils. As illustrated, the air handler cabinet 10 also receives refrigerant fluid on a line 16 from a main engine condenser coil 24 shown in FIG. 5, but not in FIG. 1, and returns refrigerant on a line 18 to a main engine compressor designated as 20. Although not shown in FIG. 1, heated engine coolant from the main vehicle engine 22 is also conducted to the air handler cabinet 10. The main engine compressor unit 20 is powered by main vehicle engine 22, which is designed for providing mobility to the recreational vehicle, and which typically has an alternator 23 that supplies 12 volt DC power. This same engine 22 supplies heated anti-freeze or other engine coolant to the air handler cabinet 10 on lines not shown in FIG. 1 but illustrated in FIG. 5.

For convenience, reference will now be made to FIG. 5 where main engine 22, along with the main engine driven compressor 20 and the lines 16, 18 are designated. In addition, a main condenser coil 24, located in the main engine compartment, is shown receiving refrigerant fluid output from main compressor 20. A fan blade 26 is shown powered by engine 22 through a drive shaft as indicated by a dash-line 28. The drive mechanism from engine 22 to compressor 20 is shown by a dash-line 30. In most engine driven air conditioning systems, the compressor 20 is driven by one or more belts 30 while the engine coolant cooling fan 26 is typically driven by a power shaft coming out of the front of the engine. This shaft often powers an engine coolant circulating pump 32, which supplies coolant fluid from the engine 22 through a conduit or line 34 to an engine radiator 36. The fluid after passing through radiator 36 is returned to the engine on a line 38. It is of course within the scope of the invention that the cooling fan for this in-transit condenser be operated by a vehicle battery powered electric motor.

An engine coolant line 40 is shown connected through a valve 42 to a secondary heat exchange coil 44 in air handler cabinet 10 for supplying heat to the additional area or passenger space of the vehicle away from the driver area. The valve 42 is operated mechanically by a control wire 45 which may be connected to a knob located on the dash of the vehicle. The secondary heat exchange coil 44 returns engine coolant fluid on a line 46 to the line 38 and accordingly to engine 22. Heated engine coolant will also go to a main heat exchanging coil 41 in the driver compartment of the recreational vehicle, and this is shown by a high water pressure dash line 48 connected to line 40 and a dash return water line 50 connected to line 38 coming from the recreational vehicle cab heater 41. A main fan 63 moves air through primary heater coil 41 and out outlets of the dashboard. Fan or blower 63 typically has a 12 volt motor that is supplied with power from the vehicle's batteries (not shown) and main engine alternator 23.

Optionally, the vehicle may have a diesel-fired boiler or hot water heater 65 that is connected into a pressurized water system (not shown) of the vehicle. The pressurized water system typically includes a pump and an accumulator. Boiler 65 supplies hot water in a conventional manner for a shower and sinks. In addition, boiler 65 may be connected to a circulating pump 67, which in turn is connected by lines 69 to either secondary heat exchanger 44 or alternatively to a third heat exchanger 71 located in air handling cabinet 10 adjacent secondary heat exchanger 44.

As is typical of most air conditioned vehicles, outside air is drawn in through the vehicle grill, through the engine compartment air conditioner condenser coil 24, the engine radiator 36, and then used to also cool the engine 22. After the refrigerant fluid obtained from compressor 20 is cooled in main heat exchanger coil 24, it is supplied on a line 52 through a receiver reservoir 54 and an expansion valve 56 to a secondary evaporator coil 58 in air handler cabinet 10 via line 16. A dashline 60 shows the high pressure refrigerant also being supplied to a cab or main evaporator coil 61, typically mounted in the heating cooling duct work within the dashboard of the driver's compartment of the recreational vehicle. Fan 63 moves air through main evaporator coil 61.

The refrigerant, after cooling air flowing through the secondary evaporator coil 58, is returned to main compressor 20 via previously designated line 18 and an accumulator, surge drum, or surge header reservoir 59. Reservoir 59 provides a chamber for storing low-side liquid refrigerant in a refrigeration system to prevent slugging (i.e. ingestion of liquid rather than gas) of main compressor 20 due to varying conditions of air flow through air handler cabinet 10 and associated evaporator coils from auxiliary fan 70. A dash-line 62 returns refrigerant to accumulator 59 and to main compressor 20 from dashboard evaporator coil 61 in the vehicle driver's compartment.

It will be noted that heater coils 44, 71 and evaporator coil 58 are arranged side-by-side in air handler cabinet 10 to accommodate serial flow heat exchange, and the three are further coupled to heat exchanger evaporator coils 64 and 66 of two separate auxiliary heating and cooling systems, also located in air handler cabinet 10. An auxiliary AC electrical motor designated M2 and also as 68 is used to power an auxiliary fan 70 which draws air serially through each of the coils 44, 71, 58, 64 and 66, and discharges this air to the previously designated duct work 14 of FIG. 1.

A first auxiliary compressor designated as 72 (C2) is located in air handler cabinet 10. First auxiliary compressor 72 has a 120 volt AC motor incorporated within it. First auxiliary compressor 72 supplies high pressure freon or refrigerant through an auxiliary condenser coil designated as 74 and an expansion valve 78, to the previously mentioned auxiliary evaporator coil 66 and back through an accumulator reservoir 76 to a suction input side of auxiliary compressor 72. Auxiliary condenser coil 74 and expansion valve 78 are also located in air handler cabinet 10.

The auxiliary cooling system optionally may also include a second auxiliary compressor 80 (C3), which has a similar set of components, including an auxiliary condenser coil 82 and an expansion valve 86, serially connected to pass refrigerant to the previously mentioned auxiliary evaporator coil 64 and return the freon through an accumulator reservoir 84 to the suction input of second auxiliary compressor 80. Second auxiliary compressor 80 has a 120 volt AC motor that is incorporated within it. A second auxiliary AC electrical motor 88 is shown powering a fan 90 for passing outside cooling air through the auxiliary condenser coils 74 and 82 and discharging this air to the environment. Second auxiliary compressor 80, expansion valve 86 and condenser coil 82 are also located in air handler cabinet 10.

Both of the auxiliary motors 68 and 88 are preferably multi-speed 120 volt AC motors to assist the overall system in preventing damage to auxiliary compressors 72, 80 due conditions of inadequate air flow causing the evaporator coils to ice over and often further causing liquid freon to pass into the compressors 72, 80 themselves when accumulators are not used, or inadequate air flow through the coils 74, 82, causes extremely high head pressures in the compressors 72, 80. Either of these situations potentially causes damage to mechanical parts of associated compressors. Normally auxiliary compressors 72, 80 and the associated auxiliary condensers 74, 82 and evaporators 64, 66, operate with a different refrigerant than the refrigerant used with main compressor 20, main condenser 24, main evaporator 61, and main secondary evaporator 58. The reason is that the auxiliary system compressors 72, 80 are powered by 120 volt AC power while the main system compressor 20 is powered by main engine 22. For example, the auxiliary system may use R-22 refrigerant while the main system uses R-134.

Referring now to FIG. 2, it will be noted that air is shown flowing in from the return air duct 12 through the two secondary heat exchanger coils 44, 58 of the main heating and cooling system and auxiliary heat exchanger coils 64 and 66 of the auxiliary system. The air is drawn in by a 120 volt AC motor 68 powering fan blade 70 within an undesignated housing and output through duct work 14 to be returned as conditioned air to the additional area of the recreational vehicle spaced from the driver area. Also shown is 120 volt AC fan motor 88, which powers fan 90 and pulls air through the auxiliary condenser coils 74, 82.

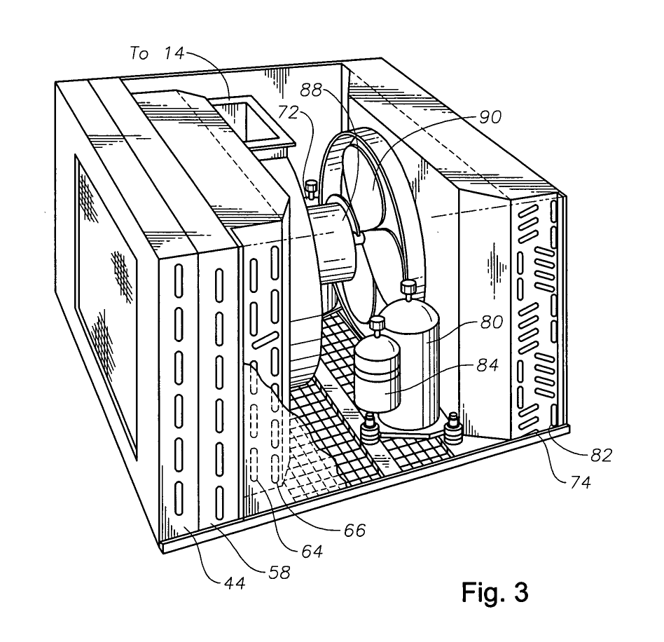

FIG. 3 shows substantially the same components as shown in FIG. 2 and in addition, the second auxiliary compressor 80 and its associated accumulator reservoir 84 are shown on one side of the unit with compressor 72 shown on the other side.

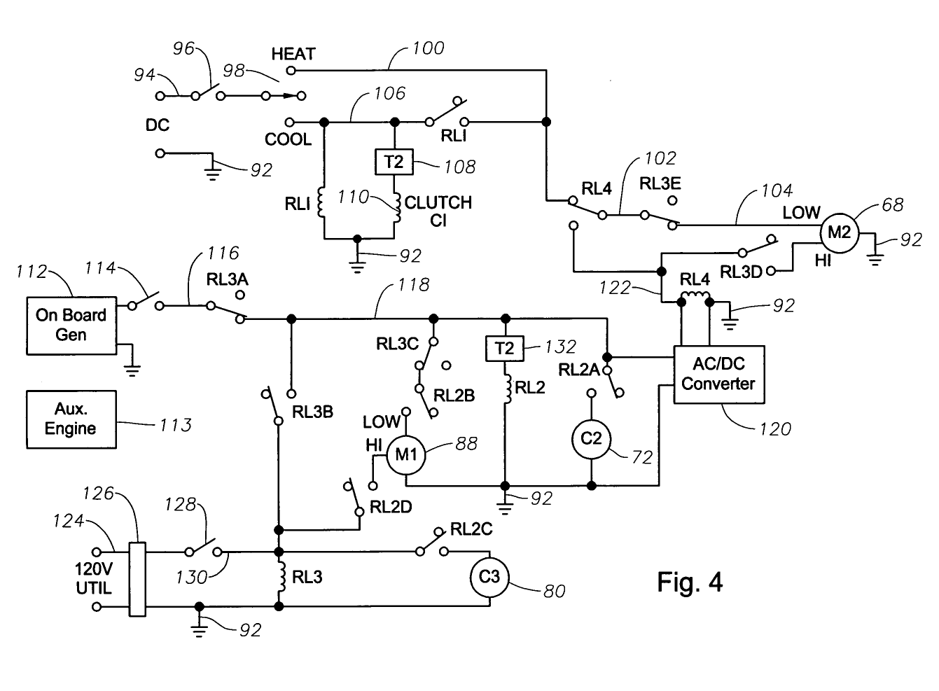

In FIG. 4, the previously designated auxiliary compressors 72, 80 and motors 68, 88 are shown connected to electric circuitry for operation in various modes. A DC source from alternator 23 of main engine 22 (FIG. 5) supplies voltage to induce a current between ground 92 and a positive lead 94. The operating power typically is provided by the main battery of the recreational vehicle with the assistance of an on-board 12 volt alternator 23, which is belt-driven by main engine 22. An ignition switch designated as 96 is shown for supplying power to a HEAT or COOL switch which has a normally OFF center position. This switch is designated as 98.

A lead 100 is connected a direct current (DC) input of a 12 volt DC to 115 volt alternating current (AC) power converter designated as 120, also called an inverter. An AC output of converter 120 is labeled 122 and supplies AC power to a normally closed contact of a set of relay contacts designated as RL4, which relay contacts are further connected via a lead 102 through a set of normally closed relay contacts RL3E (E being the designation for the fifth set of contacts for the relay coil RL3) to a low speed input of motor 68 on a low speed lead 104. The motor 68 also has a lead connected to ground 92. Converter 120 has sufficient capacity to supply AC power to fan motors 68, 88 while the vehicle is in transit if heating and cooling of the living space is desired. However, in this embodiment, converter 120 is not sufficiently large to power either of the AC auxiliary compressors 72, 80.

The cool contact of HEAT/COOL switch 98 is connected to a lead 106 which supplies power to a coil of a relay RL1 who's other side is connected to ground 92. Lead 106 is also connected through a thermostat 108, also designated as T1, and through a coil 110 to ground 92. The coil 110 activates a clutch for the main engine driven compressor C1 (20). Lead 106 is connected through a set of contacts labeled RL1 to the previously designated lead 100. As shown, RL1 is normally open (NO) but the contacts close upon energization of relay coil RL1.

The vehicle preferably has an on-board 120 volt alternating current (AC) power provider, which in this example comprises generator 112, but other devices capable of supplying 120 AC voltage are feasible. Generator 112 is connected through a normally open switch 114 to a lead 116. Generator 112 is driven by an auxiliary engine 113 carried by the vehicle. In this embodiment, generator 112 is capable of supplying the necessary AC power to operate auxiliary compressor 72 and the AC fan motors 68, 88. A normally closed set of relay contacts RL3A connects lead 116 to a lead 118. Lead 118 supplies a hot lead or non-grounded lead alternating signal to one side of a relay coil RL4 having its other lead connected to ground 92. Lead 118 is also connected to the normally open contact of the contacts RL4 previously designated, and to a lead of a normally open set of contacts designated as RL3D. An output o£ the switch contacts RL3D is connected to the high speed input lead of motor 68. Optionally, generator 112 could be sized to power both auxiliary compressors 72, 80 simultaneously.

A 120 volt AC utility source is connected between ground 92 and a hot lead or non-grounded lead 124. While the vehicle is not traveling, the operator may connect to an electrical receptacle on the vehicle via a power cord extending to a 120 volt AC utility power source. If so, the 120 volt utility power can be used to simultaneously operate both auxiliary compressors 72, 80 and the AC fan motors 68, 88. The lead 124 is connected through an electrical plug or other disconnectible interface 126 to an ON-OFF switch 128. An output of the ON-OFF switch 128 is connected to a lead 130. A coil of a relay RL3 is connected between lead 130 and ground 92. Lead 130 is also connected to normally open set of relay contacts labeled as RL2C.

The normally unswitched terminal of switch RL2C is connected to one side of the compressor 80, which is also designated as C3 and whose other side is connected to ground 92. The lead 130 is further connected to one end of a normally open set of switch contacts RL3B, whose normally open contact is connected to lead 118. Lead 130 is also connected to a normally open set of contacts labeled RL2D. The normally unconnected contact of contacts RL2D is connected to the high speed lead of a motor 88, also designated as motor M1. A low speed lead of motor 88 is connected to a normally open terminal of a set of normally open contacts RL2B and then through a normally closed set of contacts RL3C to lead 118.

A thermostat labeled T2 and designated as 132 is connected in series with a coil for relay RL2 between ground 92 and the lead 118. A set of normally open relay contacts designated as RL2A is connected in series with a compressor 72 also designated as C2 between lead 118 and ground 92.

Referring to both FIGS. 4 and 5, if heating is desired for the conditioned air space in the living area of the recreational vehicle while the vehicle is in transit, switch 96 for the ignition has already been closed to start main engine 22 (FIG. 5) and the switch 98 is turned to the upper or HEAT position. The valve 42 may be opened using the mechanical connection 45 to open same from the dashboard, and heated fluid is transmitted to the core or heat exchanging coil 44 due to the pressure of the fluid output from the water pump 32 attached to engine 22. With the switch 98 in the HEAT position, alternating current flows from lead 122 of AC to DC converter 120 through the relay contacts RL4 and RL3E, both of which are normally in the position shown, to the motor 68, which is the operates the fan drawing air from the return air ducts 12 in the recreational vehicle and discharging same through the conditioned air outlets 14. The motor 68 can typically run in the low speed condition for heated air to be adequately distributed. Coolant from main engine 20 is simultaneously circulated through the dashboard or main heater coil 41 in a conventional manner for heating the cab area.

Heat can also be distributed through air ducts 12 while in transit by using diesel-fired boiler 65. When actuated, pump 67 will circulate water heated by boiler 65 through heat exchanger 71. Fan 70 moves air through heat exchanger 71 into ducts 12. When parked, and the outside temperature above about 40 degrees F., preferably compressors 73 and 80 are operated in a heat pump mode for heating the vehicle. The heat pump mode is conventional, and when an air refrigeration unit is used to heat air, the action of the condensers 74, 82 and evaporator coils 64, 66 are interchanged. If the outside temperature is below about 40 degrees F., diesel-fired boiler 65 and pump 69 are preferably operated to circulate hot water through heat exchanger 71. The electrical power when parked can be either by the onboard generator or by utility line power.

If it is desired to cool the living space of the recreational vehicle while in transit, the switch 98 is switched to the lower or COOL position to apply power to relay coil RL1. This will activate the switch contacts RL1 from the normally open position to a closed position so that alternating current can again flow through the previously described path of the contacts of RL4 and RL3E to the motor 68 and it is again activated in the low speed condition. The thermostat 108, when it is calling for cooling, will allow through coil 110 and activate the clutch for main engine compressor 20 so that freon is circulated through the main condenser coil 24, the expansion valve 56 and the secondary evaporator coil 58 before being returned to main compressor 20. The air is circulated in the living space of the recreational vehicle by the motor 68 as mentioned above. The refrigerant gas is simultaneously circulated through a further expansion valve and evaporator coil 61 in the driver's compartment of the recreational vehicle in a manner standard in the industry.

The main compressor 20 might only be able to cool the entire recreational vehicle, including the driver's compartment, when the outside temperatures are fairly moderate. If more cooling is necessary while traveling, the on-board generator 112 and its auxiliary engine 113 would be activated and switch 114 would be closed. Power would then flow through the coil of relay RL4, thereby changing the position of the contacts RL4 so that power is supplied through lead 118 to lead 102 and through the contacts of normally closed switch RL3E to the low speed of motor 68.

In this mode, air is again circulated through the recreational vehicle. The thermostat 132 allows activation of the relay coil RL2 to close switch contacts RL2A and RL2B. This activates both the auxiliary compressor 72 and condenser fan motor 88. Compressor 72 can then circulate refrigerated fluids through the heat exchanger coils 74 and 66 in the conventional fashion to supply additional cooling to the recreational vehicle over that supplied by the engine driven compressor 20. The fan motor 68 in the low speed condition will typically still supply adequate air flow across the juxtaposed coils in air handler 10 to keep them from icing over if the freon levels are properly adjusted in the refrigerant paths for compressors 20 and 72 (in other words while both are running on an adequately warm day).

If desired, air handler motors having more than two speeds may be utilized and the circuitry illustrated may be modified to run at different speeds, whether 1, 2 or 3 compressors are supplying refrigerant to the multiple heat exchangers.

When the vehicle is parked at a source of utility company power, and plugged in via the receptacle connection 126, the switch 114 can be closed to activate relay coil RL3. This will disconnect the power from on-board generator 110 to compressor 72 by opening contacts RL3A and will disconnect the application of power to the low speed terminal of condenser fan motor 88 by opening normally closed relay contacts RL3C. At the same time, power will be applied from the utility company to lead 318 via the closing of normally open relay contacts RL3B. This will activate the thermostat 132 and again activate the coil of relay RL2 to close the contacts of RL2A to activate auxiliary compressor 72, close contacts RL2D to activate the high speed terminal of compressor fan motor 88 and close normally open contact RL2C to activate compressor 80.

It may be noted that the activation of coil RL3 opens the normally closed contacts RL3E and closes the contacts RL3D to place the common air handler fan motor 68 in the high speed condition. Thus, for operating the two auxiliary compressors 72 and 80, the air handler fan motor 68 is in the high speed position drawing or circulating air throughout the recreational vehicle at a speed which will prevent icing over of the evaporator coils. Further the motor 88 is also in the high speed condition and is passing enough air over the condenser coils 74 and 82 to prevent excessive head pressures in the compressors 72 and 80.

Although typically the two auxiliary compressors 72 and 80 would be adequate in a situation where the vehicle is parked to cool the entire recreational vehicle, the air flow provided by fan motor 68 in the high speed condition would normally be adequate to prevent icing over of the evaporator coils if it was determined that it was so hot that the engine compressor 20 needed to be used for cooling the vehicle in addition to the other two compressors 72 and 80.

As set forth in this preferred embodiment, when air conditioning is called for, whether heating or cooling, the air handler fan motor 68 preferably runs continuously, and the cycling of condenser fan motor 88 in response to thermostat 132 would not affect air being circulated in the recreational vehicle by the air handler motor 68. Again, the circuitry illustrated can readily be modified to turn off the air handler motor 68 when the proper temperature is reached in the recreational vehicle and no compressors are operating.

The system thus has several modes of operation. The vehicle may be driven on the road with heat or cooling supplied conventionally only through the dashboard vents. Referring to FIG. 5, for heat, engine coolant from radiator 36 is circulated through heater coil 41, and vehicle air handling fan 63 moves air through heater coil 41. For cooling, main compressor 20 circulates refrigerant through main condenser 24 and evaporator 61, and fan 63 moves air through evaporator 61.

For heating the living space while in transit, the operator would continue to supply heat through main heater coil 41 and main fan 63 and in addition open valve 42 to supply main engine coolant from radiator 36 to secondary heater coil 44 in air handler cabinet 10. Fan motor 68 would be activated to continuously circulate the heated air through ducts 14 (FIG. 1). Optionally, the operator could supply heat through diesel-fired boiler 65, which circulates hot water through heat exchanger 71. Fan 70 moves air through heat exchanger 71 and into ducts 14.

For cooling the living space while in transit using only the main cooling system, the operator would typically continue to supply refrigerant from main compressor 20 to main condenser 24 and evaporator 61, and in addition begin supplying refrigerant to secondary evaporator 58 in air handler cabinet 10. Fan motor 68 would be activated to circulate the cooled air through ducts 14 (FIG. 1).

If additional cooling is needed while in transit, the operator could start auxiliary engine 113 and on board generator 112 to supply AC power to auxiliary compressor 72. In that event, compressor 72 circulates refrigerant through auxiliary condenser 74 and auxiliary evaporator 66, and condenser fan 88 moves air across condenser 74. Fan 68 would continue to operate.

For cooling while parked near a utility power source, 120 volt utility power can be used to operate one or both compressors 72, 80 and to supply AC power to fans 68 and 88. Main fan 63 and main compressor 20 would not be running in this mode. For heating while parked near a utility power source, if the weather is not below about 40 degrees F., one or both auxiliary compressors 72, 80 could be run in a heat pump mode. Alternately, a supplemental heater (not shown), such as a diesel heater, could be employed.

While in the foregoing specification a detailed description of a specific embodiment of the invention has been set forth for the purpose of illustration, it will be understood that many of the details given herein may be varied considerably by those skilled in the art without departing from the spirit and scope of the invention. For example, while a receiver reservoir has only been shown for use in the vehicle engine driven refrigeration system using compressor 20 where there is typically a wide range of air flow volume through the condenser coil, such a reservoir could readily be added to the systems utilizing compressors 72 and 80. Accordingly, the present invention is intended to be limited only by the scope of the appended claims and the applicable prior art.

1. A vehicle having a main engine for propelling the vehicle and a main air conditioning system including a main compressor driven by the main engine for circulating a first refrigerant through a main condenser and a main evaporator, and a main fan for discharging air through the main evaporator into a driver area of the vehicle, the improvement comprising:
an air supply duct extending through an additional area of the interior of the vehicle and having at least one outlet;
an air handling cabinet having a conditioned air outlet connected with the supply duct;
a secondary evaporator in the cabinet and connected with the main compressor for selectively receiving first refrigerant simultaneously with the main evaporator;
an auxiliary air conditioning system including an AC powered auxiliary compressor that circulates a second refrigerant through an auxiliary condenser and an auxiliary evaporator, the auxiliary evaporator being located in the cabinet;
an on board auxiliary power provider driven by an auxiliary engine for selectively supplying AC power to the auxiliary compressor;
an additional area fan for circulating air through the secondary evaporator and the auxiliary evaporator into the duct;
the vehicle having a first in transit mode wherein the auxiliary air conditioning system is not operating and the main air conditioning system is operating along with the secondary evaporator, the main air fan moves air cooled by the main evaporator into the driver area and the additional area fan moves air cooled by the secondary evaporator into the duct and the additional interior of the vehicle; and
the vehicle having a second in transit mode wherein both the main air conditioning system along with the secondary evaporator and the auxiliary air conditioning system are operating, along with the auxiliary power provider, the main air fan moves air cooled by the main evaporator into the driver area and the additional area fan moves air cooled by the secondary and auxiliary evaporators into the duct and the additional interior of the vehicle.

2. The vehicle according to claim 1, further comprising:
a DC to AC converter for converting DC power supplied by an alternator of the main engine to AC power; and
wherein the additional area fan has an AC motor that is powered by the AC power supplied by the converter during the first in transit mode and by the AC power supplied by the auxiliary power provider during the second in transit mode.

3. The vehicle according to claim 1, wherein the first refrigerant differs from the second refrigerant.

4. The vehicle according to claim 1, wherein while in the first in transit mode, the additional area fan moves air through the auxiliary evaporator even through the auxiliary evaporator is non functional during the first in transit mode.

5. The vehicle according to claim 1, further comprising:
an auxiliary fan for discharging air through the auxiliary condenser to an exterior of the vehicle, the auxiliary fan being driven by an AC motor that is supplied with AC power from the auxiliary power provider during the second in transit mode.

6. The vehicle according to claim 1, further comprising:
an electrical receptacle for connection to a power cable leading from a utility source of AC power, and wherein
the vehicle has a parked mode wherein the main air conditioning system is not operating and the auxiliary air conditioning system and the additional area fan are operating with the AC power supplied by the utility source, and wherein the additional area fan moves air that is cooled by the auxiliary evaporator into the duct and the additional area of the vehicle.

7. The vehicle according to claim 6, wherein while in the parked mode, the additional area fan moves air through the secondary evaporator even through the secondary evaporator is non functional during the parked mode.

8. The vehicle according to claim 1, further comprising:
a main heater coil in the driver area coupled to a radiator of the main engine;
a secondary heater coil in the cabinet and coupled to the radiator of the main engine; and
the vehicle having a third in transit mode wherein the main fan moves air heated by the main heater coil into the driver area, and the additional area fan moves air heated by the secondary heater coil into the duct and the additional interior of the vehicle.

9. The vehicle according to claim 1, further comprising:
a diesel-fired hot water heating unit;
a heat exchanger in the cabinet and coupled to the heating unit for receiving hot water circulated by the heating unit; and
the vehicle having a heating while in transit mode wherein the additional area fan moves air heated by the heat exchanger into the duct and the additional interior of the vehicle.

10. The vehicle according to claim 1, further comprising:
a second auxiliary air conditioning system, the second auxiliary air conditioning system having an AC powered second auxiliary compressor that circulates a third refrigerant through a second auxiliary condenser and a second auxiliary evaporator, the second auxiliary evaporator being located in the cabinet; and wherein
the additional area fan moves air through the second auxiliary evaporator into the duct.

11. A vehicle having a main engine for propelling the vehicle, the main engine having an alternator for generating DC power and being cooled by a radiator, the vehicle having a main heating and air conditioning system including a main compressor driven by the main engine for circulating a first refrigerant through a main condenser and a main evaporator, a main heater coil through which coolant from the radiator is circulated, and a main fan for discharging air through the main evaporator and the main heater coil into a driver area of the vehicle, the improvement comprising:
an air supply duct extending along an interior of the vehicle and having a plurality of outlets in an additional area of the interior of the vehicle;
an air handling cabinet having a conditioned air outlet connected with the supply duct and a return air inlet for receiving returning air from the additional area of the vehicle;
a secondary evaporator in the cabinet in a flowpath between the conditioned air outlet and the return air inlet and connected with the main compressor for selectively receiving first refrigerant simultaneously with the main evaporator;
a secondary heater coil in the cabinet in the flowpath and selectively connected with the radiator for receiving coolant from the radiator;
an auxiliary air conditioning system in the cabinet including an AC powered auxiliary compressor that circulates a second refrigerant through an auxiliary condenser and an auxiliary evaporator, the auxiliary evaporator being located in the flowpath;
an on board auxiliary power provider driven by an auxiliary engine for selectively supplying AC power to the auxiliary compressor;
an AC additional area fan for circulating air moving air through the flowpath into the duct;
a power converter for converting DC power from the alternator to AC power for use by the additional area fan while the auxiliary power provider is not operating and the main engine is operating;
the vehicle having a first in transit cooling mode wherein the auxiliary air conditioning system is not operating and the main air conditioning system is operating, the main air fan moves air cooled by the main evaporator into the driver area and the additional area fan moves air along the flowpath through the secondary heater coil, the secondary evaporator, and the auxiliary evaporator into the duct and the additional interior of the vehicle, the air in the flowpath being cooled by the secondary evaporator; and
the vehicle having a second in transit cooling mode wherein both the main air conditioning system and the auxiliary air conditioning system are operating, the main air fan moves air cooled by the main evaporator into the driver area and the additional area fan moves air along the flowpath through the secondary heater coil, the secondary evaporator, and the auxiliary evaporator into the duct and the additional interior of the vehicle, the air in the flowpath being cooled by the secondary evaporator and the auxiliary evaporator.

12. The vehicle according to claim 11, wherein:
the vehicle has an in transit heating mode wherein the main fan moves air heated by the main heater coil into the driver area, and the additional area fan moves air heated by the secondary heater coil into the duct and the additional interior area of the vehicle.

13. The vehicle according to claim 11, wherein the first refrigerant differs from the second refrigerant.

14. The vehicle according to claim 11, further comprising:
an auxiliary fan for discharging air through the auxiliary condenser to an exterior of the vehicle, the auxiliary fan being driven by an AC motor that is supplied with AC power from the auxiliary power provider during the second in transit cooling mode.

15. The vehicle according to claim 11, further comprising:
an electrical receptacle for connection to a power cable leading from a utility source of AC power, and wherein
the vehicle has a parked mode wherein the main air conditioning system is not operating and the auxiliary air conditioning system and the additional area fan are operating with the AC power supplied by the utility source, and wherein the additional area fan moves air that is cooled by the auxiliary evaporator into the duct and the additional area of the vehicle.

16. The vehicle according to claim 11, further comprising:
a second auxiliary air conditioning system in the air handling cabinet, the second auxiliary air conditioning system having an AC powered second auxiliary compressor that circulates a third refrigerant through a second auxiliary condenser and a second auxiliary evaporator; and wherein
the second auxiliary evaporator is located in the flowpath so that whenever the additional area fan is operating, air moves through the second auxiliary evaporator whether or not the second auxiliary evaporator is functioning.

17. The vehicle according to claim 1, further comprising:
a diesel-fired hot water heating unit;
a hot water heating coil in the cabinet and coupled to the heating unit for receiving hot water circulated by the heating unit; and
the vehicle having a heating while in transit mode wherein the additional area fan moves air heated by the hot water heating coil into the duct and the additional interior of the vehicle.

18. A method of cooling a vehicle while in transit, the vehicle having a main engine and a main air conditioning system including a main compressor driven by the main engine, a main condenser and a main evaporator, the method comprising:
(a) installing a secondary evaporator, an auxiliary compressor, auxiliary condenser, and auxiliary evaporator, and installing an on board AC power provider driven by an auxiliary engine;
(b) in a first in transit mode, while the auxiliary compressor is not operating, operating the main compressor with the main engine, circulating a first refrigerant through the main evaporator and the secondary evaporator, moving air cooled by the main evaporator into the driver area, and moving air cooled by the secondary evaporator into an additional area of the vehicle; and
(c) in a second in transit mode, continuing step (b) except operating the auxiliary compressor with AC power supplied by the AC power provider and the auxiliary engine, and moving air cooled by the secondary evaporator and the auxiliary evaporator into the additional area of the vehicle.

19. The method according to claim 18, wherein:
in step (b) an additional area fan moves air through the secondary evaporator while a main fan moves air through the main evaporator; and
in step (c) the additional area fan moves air through the secondary evaporator and the auxiliary evaporator.

20. The method according to claim 18, wherein the main engine has an alternator that supplies DC power; and the method further comprises:
during step (b) converting a portion of the DC power to AC power and powering the additional area fan therewith; and
during step (c) powering the additional area fan with AC power provided by the AC power provider.
